(19) United States
(12) Patent Application Publication
(10) Pub. No.: US 2013/0282365 A1
(43) Pub. Date: Oct. 24, 2013

(54) ADAPTING LANGUAGE USE IN A DEVICE

(71) Applicants: Adriaan Van De Ven, Portland, OR (US); Auke-Jan H. Kok, Hillsboro, OR (US); Marjorie L. Foster, Hillsboro, OR (US)

(72) Inventors: Adriaan Van De Ven, Portland, OR (US); Auke-Jan H. Kok, Hillsboro, OR (US); Marjorie L. Foster, Hillsboro, OR (US)

(21) Appl. No.: 13/976,940

(22) PCT Filed: Oct. 28, 2011
(86) PCT No.: PCT/US11/58403

§ 371 Date: Jun. 27, 2013

(51) Int. Cl. G06F 17/27

(52) U.S. Cl. CPC G06F 17/27
USPC 704/9

(57) ABSTRACT

In several non-English languages and cultures, such as Dutch and German, there is a formal and informal language form used to address a person. A device having a user interface is adapted for use with both formal and informal language. A user's preferred language form can change over time, and is determined directly or indirectly from characteristics of the user based on their use of the device, including how long the device has been used, a role of the user and/or his or her location. Another way of determining the characteristics of the user is to monitor the user's online behavior, including such data as social networking traffic, web sites visited, email and chat use, and the like. An application's user interface can be dynamically changed to use the current preferred language form.

### TECHNICAL FIELD

The technical field relates generally to the use of language in user interfaces of devices.

### BACKGROUND

User interfaces of applications used in electronic devices, such as personal computers, cell phones and other types of devices are often localized for use with different languages. For example, the user interface of an application on a cell phone for navigating electronic mail or a browser can be localized for use with the German language.

In several non-English languages and cultures, such as Dutch and German, there is a formal and informal language form used to address a person. However, the localized user interfaces are generally limited to one form or the other, i.e. the formal language form or the informal language form.

### BRIEF DESCRIPTION OF THE DRAWINGS

The present invention is illustrated by way of example and not limitation in the figures of the accompanying drawings, in which like references indicate similar elements and in which:

FIG. 1 is a block diagram overview illustrating one embodiment of an adaptive language system;

FIG. 2 illustrates an example of system usage data that can be used in accordance with one embodiment of an adaptive language system;

FIG. 3 illustrates an example of location awareness data that can be used in accordance with one embodiment of an adaptive language system;

FIG. 4 illustrates an example of user/online behavior data that can be used in accordance with one embodiment of an adaptive language system;

FIGS. 5A-5B and FIG. 6 are flow diagrams illustrating embodiments of processes for adapting language for user interfaces in accordance with embodiments of an adaptive language system; and

FIG. 7 illustrates an example of a typical computer system which can be used in conjunction with the embodiments described herein.

Other features of the present invention will be apparent from the accompanying drawings and from the detailed description that follows.

### DETAILED DESCRIPTION

Methods, machine-readable tangible storage media, and data processing systems are described for an adaptive language system. In the description that follows a computing device such as a laptop computer, notebook computer, and electronic tablet or reading device, camera, cell phone, smart phone or any other type of computing device having a user interface, are collectively referred to as a device.

Numerous specific details are set forth to provide a thorough explanation of embodiments of the methods, media and systems for adapting language for user interfaces. It will be apparent, however, to one skilled in the art, that an embodiment can be practiced without one or more of these specific details. In other instances, well-known components, structures, and techniques have not been shown in detail so as to not obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g. circuitry, dedicated logic, etc.), software (such as is run on a general-purpose computer system or a dedicated machine or device), or a combination of both. Although the processes are described below in terms of some sequential operations, it should be appreciated that some of the operations described can be performed in a different order. Moreover, some operations can be performed in parallel rather than sequentially.

As noted in the Background, in several non-English languages and cultures, such as Dutch and German, there is a formal and informal language form used to address a person. However, user interfaces localized for use with such languages are generally limited to one form or the other, i.e. they are always localized using the formal language form or the informal language form, but not both.

Because user interfaces are often designed to be user-friendly such that the device appears to “communicate” directly with the user, a user interface that uses the wrong language form to address the user can make using the device feel awkward to users accustomed to appropriate use of formal and informal language.

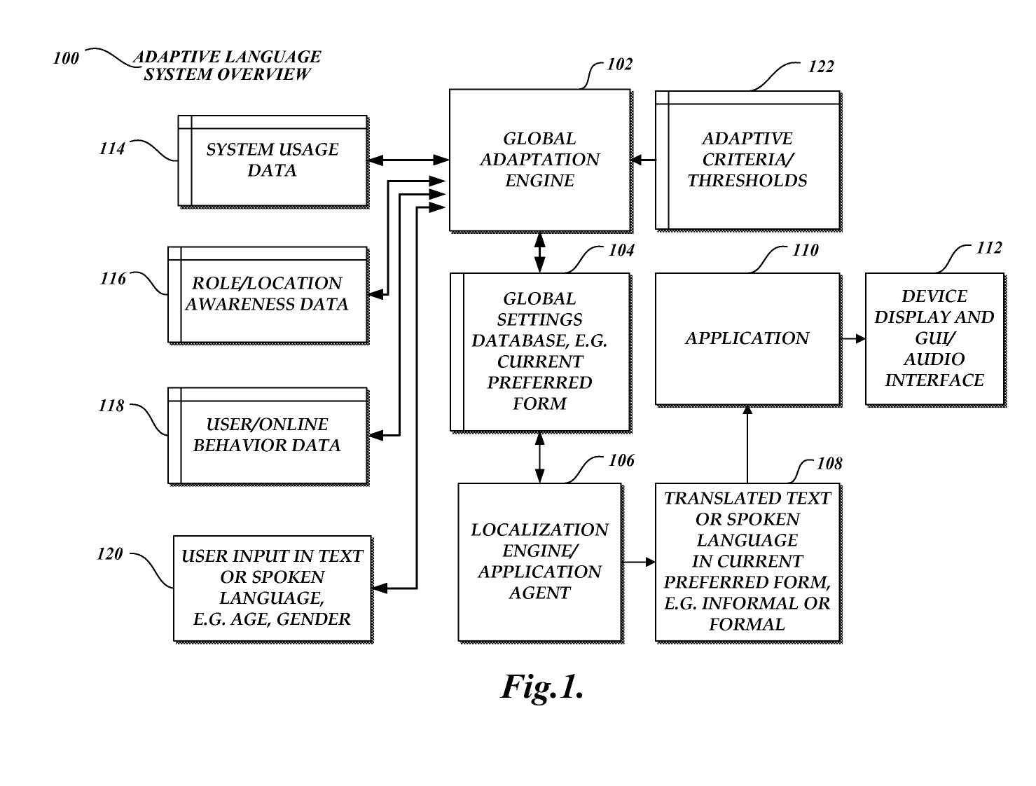

To overcome this limitation, a device having a user interface is adapted for use with both formal and informal language in accordance with embodiments of the invention as described herein. With reference to FIG. 1 illustrating one embodiment of an adaptive language system 100, a global adaptation engine 102 operates in conjunction with the device's operating system to accumulate system usage data 114 and role/location awareness data 116, to monitor user and online behavior data 118 associated with a user of the device, and/or to receive user input 120 explicitly specifying information about the user of the device.

In one embodiment, once the available data has been accumulated about system usage 114 and role/location 116, monitored from the user's behavior 118, or received from user input 120, the global adaptation engine 102 processes all of the currently available data to determine a current preferred form of language to use when generating a user interface 112.

In a typical embodiment, the processes performed by the global adaptation engine 102 measure and weigh the currently available data against adaptive language criteria 122 for determining whether to use the formal language form or the informal language form to address the user of the device. For example, the criteria 122 typically include pre-defined threshold values against which to measure the currently available data as well as how much weight to give particular data, such as the role or age of the user, the length of time the device has been used, whether the device is being used at home, work, school or at a government office, and so forth.

The processes of the global adaptation engine 102 can be performed periodically or continuously to adapt the use of language in the device based on the currently available data. In this manner, the current preferred form of language is periodically or continually updated and stored in a repository, such as a global settings database 104, which can be readily accessed as needed by a localization engine and/or application agent 106.

In one embodiment, the localization engine and/or application agent 106 uses the current preferred form of language to facilitate the translation or other generation of text or speech to be used in an application 110 in the presentation of the application's user interface 112 on the device. The application's user interface 112 can include any interface that involves the use of language, including a visual/graphical interface that displays written text, or an audio interface that uses spoken language via a speech generation capability of the device.

In one embodiment, the functionality of the application 110 may be enhanced with the use of an application agent 106 such that the application 110 is able to dynamically change the user interface 112 to reflect the current preferred form of language stored in the global settings database 104. In other embodiments, the application 110 may instead need to be restarted to reflect any changes in the current preferred form of language stored in the global settings database 104.

In one embodiment, the localization agent and/or application agent 106 may monitor the global settings database 104 for any changes in the current preferred form of language. Alternatively, or in addition, the localization agent and/or application agent 106 receives a notification from the global adaptation engine 102 when the current preferred form of language has changed.

In one embodiment, the user input 120 explicitly specifying information about the user's characteristics, such as the user's age and gender, may be affirmatively provided by the user or indirectly provided through the use of a profile. For example, the user could enter an actual age and gender or instead select an age range and gender. In one embodiment, the user could explicitly override language adaptation by specifying a formal or informal language form preference.

Another aspect of the user input 120 for a device capable of receiving and interpreting voice-based input (as opposed to pointing or touch screen input via a graphical user interface) is the user's own choice of whether to use a formal or informal language form. For example, if the user chooses to address the device using an informal language form, that choice may be stored as user behavior data 118 and used by the global adaptation engine 102 in determining whether to use the formal language form or the informal language form to address the user of the device. A change in the user's speech pattern, e.g. if the user chooses to address the device using a formal instead of informal language form, can trigger a switch in the global adaptation engine's 102 determination of whether to use the formal or informal language form.

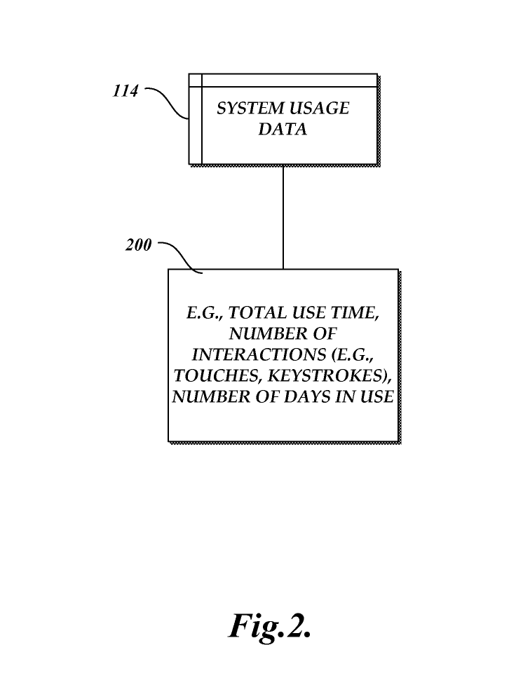

As illustrated in further detail in FIG. 2, in an example embodiment, the system usage data 114 that the global adaptation engine 102 accumulates is data related to the use of the device itself 200, such as the total amount of time that the device is in use, the number of manual interactions with a graphical user interface or spoken language interactions with an audio interface, or the number of days since the user acquired ownership of the device.

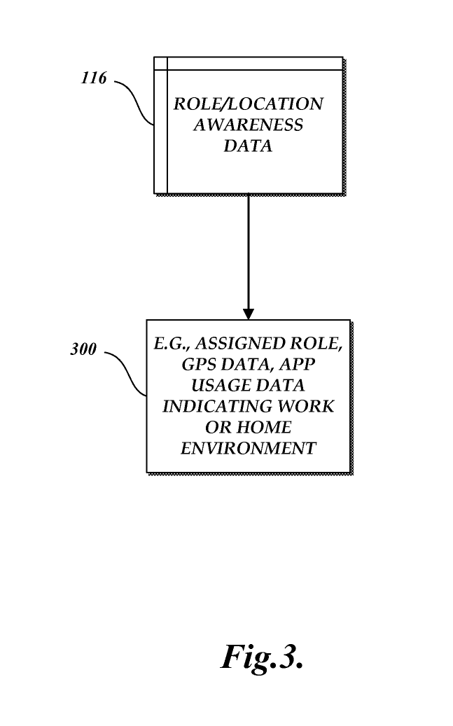

As illustrated in further detail in FIG. 3, in an example embodiment, the role/location awareness data 116 that the global adaptation engine 102 accumulates is data related to the role of the user using the device, such as a job title associated with the user or the user's level of authority for accessing resources with the device. Alternatively or in addition, the role/location awareness data 116 is data related to the location of the device, such as global positioning data that identifies whether the device is being used at work, home, school, in a government office, or at a social setting. In one embodiment, the role and location data can be inter-related such that the role of the user using the device may change depending on the location of the device. Alternatively, or in addition, the role could change depending on the time of day, or over the life of the device. For example, a police officer's role may change depending on whether the officer is on or off duty, and a teacher's role may change depending on whether the teacher is at school or at home. The role/location awareness data 116 may be ranked such that a particular role/location weighs in favor of adapting the language used in the device to an informal form versus a formal one and vice versa.

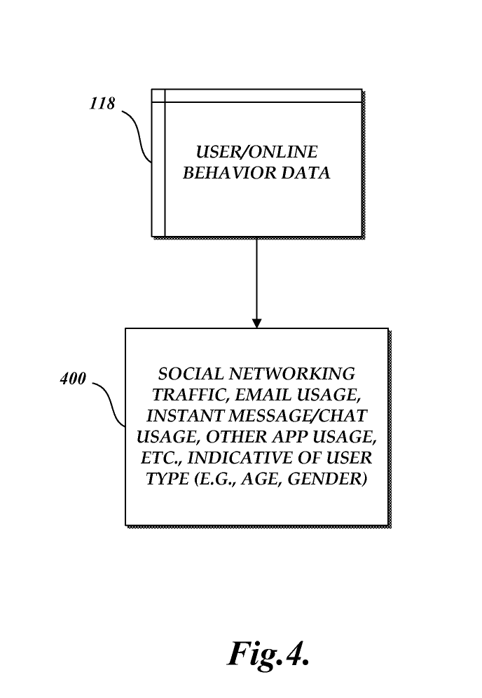

As illustrated in further detail in FIG. 4, in an example embodiment, the user/online behavior data 118 that the global adaptation engine 102 monitors is data that can be used to determine likely characteristics of the user, such as the user's age, gender and a profile representing a style of interacting with the device and others, including whether he or she addresses the device and others using an informal or formal language form. In one example, the user/online behavior data 118 that is monitored could include data related to social networking traffic transmitted and received using the device, websites or other resources accessed using the device, email usage, instant message or chat usage or other types of application usage on the device. In a typical embodiment, the likely characteristics of the user as determined from the user/online behavior data 118 may be categorized by characteristics such as age, gender and profile such that a predetermined combination of any one or more of the age, gender and profile characteristics is weighed in favor of adapting the language use to the informal form or to the formal form.

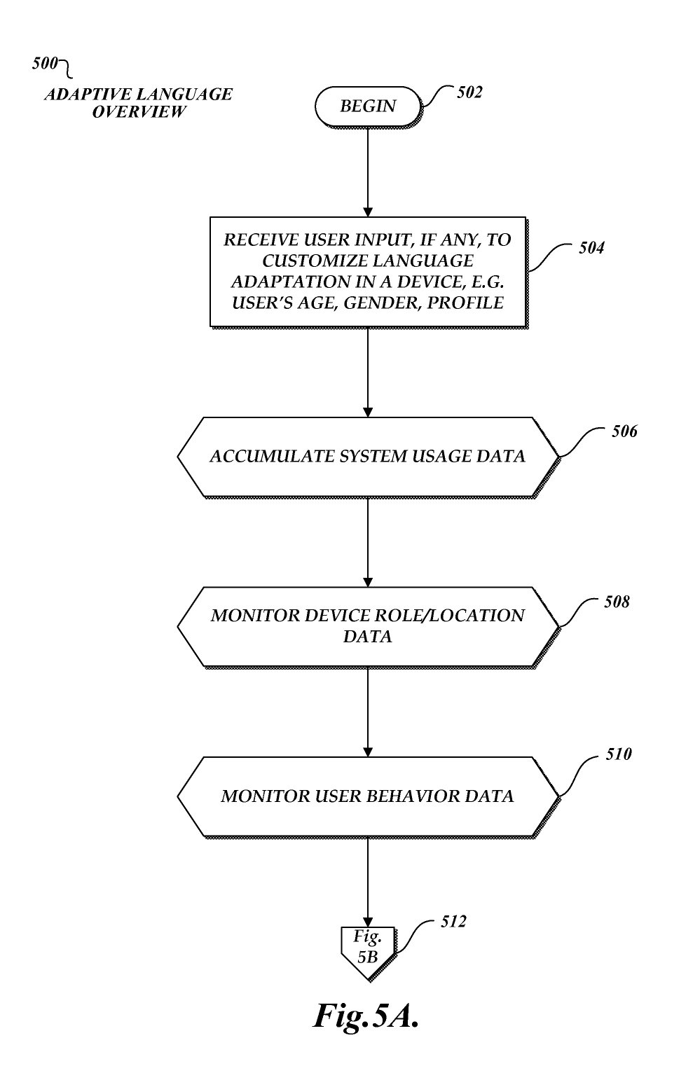

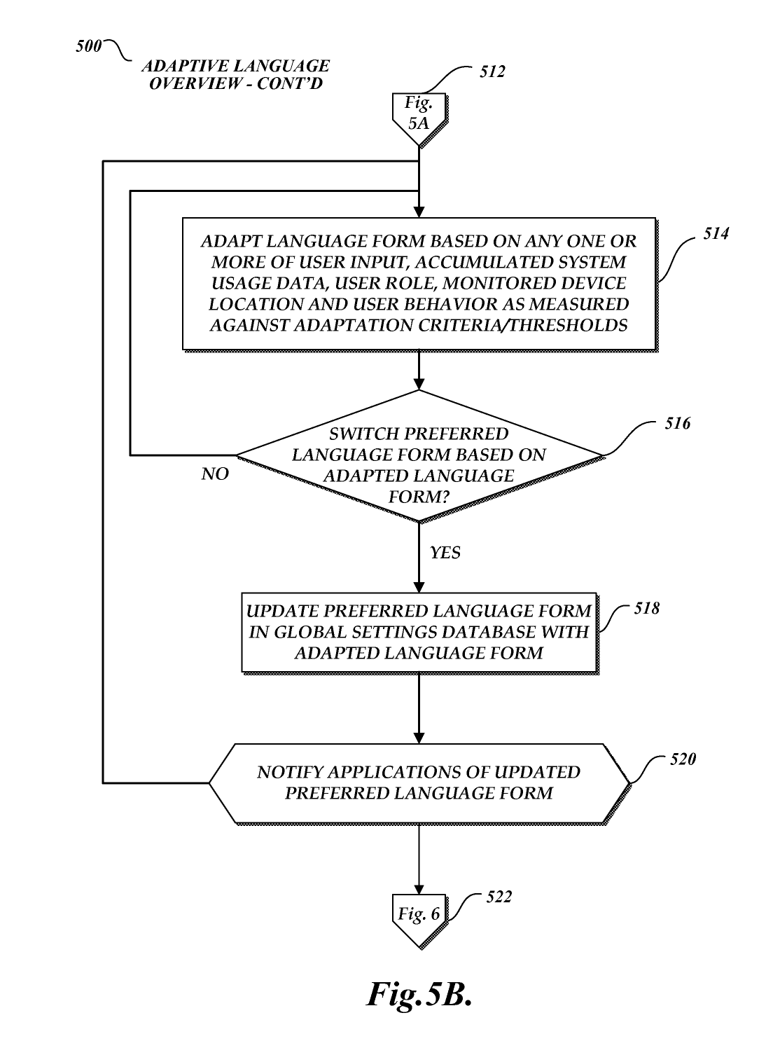

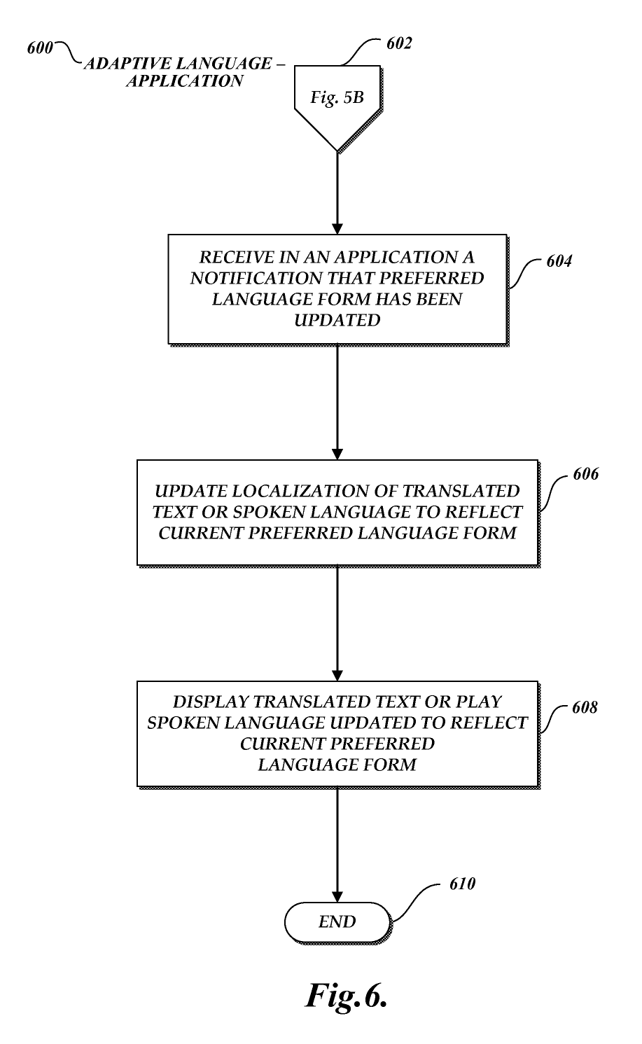

FIGS. 5A-5B and FIG. 6 are flow diagrams illustrating embodiments of processes 500 and 600 for adapting language for use in a device in accordance with an embodiment of the invention. Starting with FIG. 5A, an adaptive language process 500 begins 502 at preparation process 504, in which user input, if any, is received to customize the language adaptation in the device. For example, as noted above with reference to FIG. 1, the user may explicitly enter their age and gender either directly or through the use of a profile. In one embodiment, the user may bypass the adaptive language process 500 by specifying whether the device should use the formal or informal language form.

At preparatory process 506, the process 500 continues by accumulating system usage data, which is defined as data related to the use of the device. The process 506 of accumulating data related to the use of the device is generally ongoing, but may be terminated when a certain threshold of data is reached. For example, the process 500 may accumulate the total amount of time that the device is in use until a minimum threshold of use is reached, e.g. after 10 days or 1000 interactions with an interface on the device. In one embodiment, once the minimum threshold of use is met it may no longer be necessary to accumulate such data since the criteria for duration of use that would weigh in favor of using an informal language form is based on meeting the minimum threshold of use.

At preparatory process 508, the process 500 continues by monitoring device location data and the role of the device user relative to the location. In a typical embodiment, the device location data is obtained through the use of global positioning system data that identifies certain known locations, such as a work, home, school, government and social setting locations. The home and work locations may be manually identified to the device through user input. Other public locations, such as the school, government or social setting locations may be obtained via mapping data obtained from a mapping database, typically over a connection to a mapping resource separate from the device. In a typical embodiment, the monitored home and social settings locations would weigh in favor of an informal language form, whereas the monitored work, school and government setting would weigh in favor of a formal language form.

The role of the user may be manually identified to the device through user input. In one embodiment, the role of the user may vary depending on the current location of the device. For example, when the device is in the work location, the role may indicate a job title or security level granted to the user related to the work location. In a typical embodiment, the more senior the role of the user or the more advanced the level of security, the more likely the criteria of role/location would weigh in favor of using a formal language form. Conversely, the less senior the role of the user or the less advanced his level of security, the less likely the criteria of role/location would weigh in favor of using a formal language form. Or, as noted above, a monitored location of being at home would weigh in favor of using an informal language form while a monitored location of being at work would weigh in favor of using a formal language form, irrespective of the role of the user.

At preparatory process 510, the process 500 continues by monitoring user behavior data, such as data related to the social networking traffic transmitted and received using the device, websites or other resources accessed using the device, email usage, instant message or chat usage or other types of application usage on the device. In a typical embodiment, the user behavior data is measured against criteria such as the categories of websites or other resources accessed using the device, the user's own choice of language form and other aspects of language use (i.e., use of slang, grammar, expletives, etc.) used in the emails and chats conducted by the user with others or during interaction with the device, or a threshold amount of time spent using such applications. The user behavior data can be used to determine certain characteristics of the user, such as his or her age, gender and a profile indicative of a style of interacting with others, which in turn can be weighed along with the other criteria to determine a current preferred language form.

In a typical embodiment, the user's online behavior will vary throughout the day. Thus, the process 500 may store the accumulated and monitored data as historical data to identify certain predictable cycles of user behavior that could influence the determination of whether to use the formal or informal language form. For example, the process 500 may switch from an informal language form to a formal language form during the user's work hours based on changes in the user's online behavior, such as monitoring the user's behavior in starting up or exiting from a work-related application, or changing a style of communication in email or in his or her interaction with the device. In this manner the process 500 learns to better assess whether and when to use the formal or informal language form based on the historical data.

With reference to FIG. 5B, the process 500 continues at process block 514, in which the language form is adapted based on any one or more of the user input, accumulated system usage data and the monitored device location and role data as well as the monitored user behavior. At decision block 516, the process 500 determines whether to switch the preferred language form based on the results of the adaptation process 514. If the preferred language form is not switched, the process continues to perform the adaptation process 514 along with the preparatory processes of accumulating data 506 and monitoring data 508/510 in order to determine when it is appropriate to switch.

In a typical embodiment, if the process determines that the preferred language form should be switched, then an update process 518 is initiated in which the global settings database is updated so that the current preferred language form is the newly adapted language form. At preparatory process 520, the process 500 concludes by notifying the other applications on the device that an updated preferred language form is now available. This information is used by the applications to insure that their user interfaces always reflect the current preferred language form as will be described next with reference to FIG. 6.

FIG. 6 is a flow diagram illustrating an embodiment of a process 600 for adapting language for use in a device in accordance with an embodiment of the invention. As illustrated, an adaptive language application, which is any application that is capable of using an adapted language form, receives at process 604 a notification from the device's global adaptation engine that the preferred language form has been updated. Alternatively, or in addition, the adaptive language application may obtain this information directly from the device's global settings database without waiting to be notified.

At process block 606, the process 600 updates the localization of any translated text or spoken language used in the application's interface to reflect the current preferred language form. At process block 608, the process 600 concludes by displaying the user interface (or playing the audio interface) which has been updated to reflect the current preferred language form. In a typical embodiment, the process 600 is a dynamic one, and may be repeated as many times as needed throughout the use of the device so that the device user interfaces address the user with the current preferred language form.

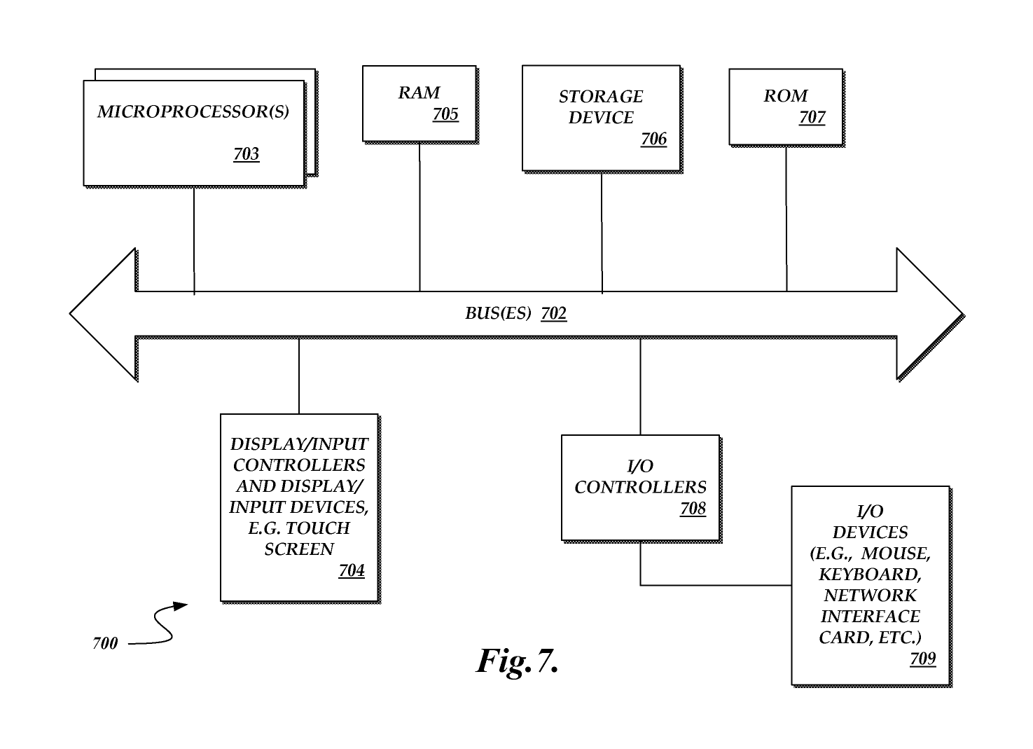

FIG. 7 illustrates an example of a typical computer system which can be used in conjunction with the embodiments described herein. Note that while FIG. 7 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 7 could also be used with the present invention.

The data processing system 700 of FIG. 7 can be any type of computing device, such as a mobile or stationary computing and/or communication device including but not limited to a cell phone, smart phone, tablet computer, laptop computer, electronic book reader, desktop computer, digital camera, etc.

As shown in FIG. 7, the data processing system 700 includes one or more buses 702 which serve to interconnect the various components of the system. One or more processors 703 are coupled to the one or more buses 702 as is known in the art. Memory 705 can be DRAM or non-volatile RAM or can be flash memory or other types of memory. This memory is coupled to the one or more buses 702 using techniques known in the art. The data processing system 700 can also include non-volatile memory 707 which can be a hard disk drive or a flash memory or a magnetic optical drive or magnetic memory or an optical drive or other types of memory systems which maintain data even after power is removed from the system. The data processing system 700 can also include a storage device 706 which can be a stationary or removable hard disk drive or a flash memory or a magnetic optical drive or magnetic memory or an optical drive or other types of memory systems which maintain data even after power is removed from the system. The non-volatile memory 707, memory 705 and storage device 706 can all be coupled to the one or more buses 702 using known interfaces and connection techniques.

A display controller/display device 704 is coupled to the one or more buses 702 in order to receive display data to be displayed on a display device 704 which can display any one of the user interface features or embodiments described herein. The display device 704 can include an integrated touch input to provide a touch screen.

The data processing system 700 can also include one or more input/output (I/O) controllers 708 which provide interfaces for one or more I/O devices 709, such as one or more mice, touch screens, touch pads, joysticks, and other input devices including those known in the art and output devices (e.g. speakers). The input/output devices 709 are coupled through one or more I/O controllers 708 as is known in the art.

While FIG. 7 shows that the non-volatile memory 707 and the memory 705 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers. As is known in the art, the one or more buses 702 may include one or more bridges or controllers or adapters to interconnect between various buses.

In one embodiment, the I/O controller 708 includes a USB adapter for controlling USB peripherals and can control an Ethernet port or a wireless transceiver or combination of wireless transceivers.

It will be apparent from this description that aspects of the present invention could be embodied, at least in part, in software. That is, the techniques and methods described herein could be carried out in a data processing system in response to its processor executing a sequence of instructions contained in a tangible, non-transitory memory such as the memory 705 or the non-volatile memory 707 or a combination of such memories, and each of these memories is a form of a machine readable, tangible storage medium. In various embodiments, hardwired circuitry could be used in combination with software instructions to implement the present invention. Thus the techniques are not limited to any specific combination of hardware circuitry and software or to any particular source for the instructions executed by the data processing system.

All or a portion of the described embodiments can be implemented with logic circuitry such as a dedicated logic circuit or with a microcontroller or other form of processing core that executes program code instructions. Thus processes taught by the discussion above could be performed with program code such as machine-executable instructions that cause a machine that executes these instructions to perform certain functions. In this context, a “machine” is typically a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture can be used to store program code. An article of manufacture that stores program code can be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions, such as a storage device 706. Program code may also be downloaded from a remote computer (e.g. a server) to a requesting computer (e.g. a client) by way of data signals embodied in a propagation medium (e.g. via a communication link (e.g. a network connection)).

The term “memory” as used herein is intended to encompass all volatile storage media, such as dynamic random access memory (DRAM) and static RAM (SRAM). Computer-executable instructions can be stored on non-volatile storage devices, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor, including the RAM 705, storage device 706, and ROM 707 as illustrated in FIG. 7.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus can be specially constructed for the required purpose, or it may comprise a general-purpose computer selectively activated or reconfigured by a computer program stored in the computer. Either way, the apparatus provides the means for carrying out the operations described herein. The computer program can be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems can be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages could be used to implement the teachings of the invention as described herein.

In the foregoing specification, the invention has been described with reference to specific exemplary embodiments. It will be evident that various modifications could be made to the described embodiments without departing from the broader spirit and scope of the invention as set forth in the following claims. The specification and drawings are, accordingly, to be regarded in an illustrative sense rather than a restrictive sense.

What is claimed is:

1. A method comprising:
adapting a language form used in a device to one of an informal or formal form based on data related to a user's interaction with the device;
updating a preferred language form with the adapted language form; and
generating a user interface on the device to reflect the preferred language form.

2. The method of claim 1, wherein adapting the language form used in the device to one of an informal or formal form based on data related to the user's interaction with the device includes:
accumulating the data related to the user's interaction with a device; and
measuring the accumulated data against a criteria for determining whether to adapt the language form to the informal or formal form, the criteria including meeting at least one threshold related to the user's interaction with the device, wherein the at least one threshold includes:
an amount of time the user spends using the device over a period of time;
a number of interactions between the user and the device via a user interface on the device;
a number of days that the device has been in use;
a number of times the user interacted with the device using an informal language form; and
a number of times the user interacted with the device using a formal language form.

3. The method of claim 1, further comprising:
adapting the language form used in the device to one of an informal or formal form based on data related to a user's location when using the device, the user's location being one of a home location, a work location, a school location, a government location and a social location.

4. The method of claim 1, further comprising:
adapting the language form used in the device to one of an informal or formal form based on data related to a user's role when using the device, the user's role being determined based on any one or more of a job title and a security level assigned to the user when using the device.

5. The method of claim 4, wherein the user's role is further determined based on the data related to a user's location when using the device, the user's location being one of a home location, a work location, a school location, a government location and a social location.

6. The method of claim 1, further comprising:
adapting the language form used in the device to one of an informal or formal form based on data related to a user's behavior when using the device, including data related to social networking traffic transmitted and received using the device, resources accessed using the device and applications used on the device, wherein the resources include websites accessed using the device and wherein the applications used on the device include email, instant messaging and chat applications.

7. The method of claim 1, further comprising:
notifying an application generating the user interface on the device that the preferred language form has been updated; and
generating the user interface on the device to reflect the updated preferred language form.

8. A system for adapting language use in a device, the system comprising:
an input receiver for receiving a user input via a user interface on a device;
a storage medium for storing a current preferred language form to use when generating the user interface on the device; and
a processor for performing processes to:
accumulate the user input via the user interface on the device,
adapt a language form used in the device to one of an informal or formal form based on the accumulated user input,
update the current preferred language form with the adapted language form, and
generate the user interface on the device to reflect the current preferred language form.

9. The system of claim 8, wherein the process to adapt the language form used in the device to one of an informal or formal form based on the accumulated user input further includes processes to:
measure the accumulated user input against a criteria for determining whether to adapt the language form to the informal or formal form, the criteria including meeting a threshold related to the accumulated user input, wherein the threshold includes any one or more of:
an amount of time the user spends using the device over a period of time;
a number of user inputs via the user interface;
a number of days that the device has been in use;
a number of user inputs using an informal language form; and
a number of user inputs using a formal language form.

10. The system of claim 8, wherein the processor is further to:
adapt the language form used in the device to one of an informal or formal form based on data monitored during use of the device, the monitored data including any one or more of:
a device location, the device location being one of a home location, a work location, a school location, a government location and a social location;
a user's role when using the device, the user's role ranked according to any one or more of a job title and a security clearance assigned to the user when using the device; and
a user's behavior when using the device, the user's behavior including any one or more of social networking traffic transmitted and received using the device, resources accessed using the device, and applications used on the device.

11. The system of claim 10, wherein to adapt the language form used in the device to one of an informal or formal form based on data monitored during use of the device, is to:
evaluate the monitored data against a criteria for adapting the language form used in the device, the criteria including any one or more of:
a type of the location, wherein device use in the home and social types of locations is weighed in favor of adapting the language to the informal form, and device use in the work, school and government types of locations is weighed in favor of adapting the language to the formal form;
a rank associated with the user's role when using the device, wherein a lower rank is weighed in favor of adapting the language to the informal form, and a higher rank is weighed in favor of adapting the language to the formal form; and
a user characteristic associated with the user's behavior when using the device, wherein the user characteristic includes any one or more of an age, gender and profile associated with the user's behavior when using the device, and further wherein a predetermined combination of any one or more of age, gender and profile weigh is weighed in favor of adapting the language to the informal form, and another predetermined combination of any one or more of age, gender and profile weigh are weighed in favor adapting the language to the formal form.

12. The system of claim 8, wherein the processor is further to:
notify an application generating the user interface on the device that the preferred language form has been updated; and
generate the user interface on the device to reflect the updated preferred language form.

13. At least one computer readable storage medium including instructions that, when executed on a machine, cause the machine to:
receive a user input via a user interface on a device;
store a current preferred language form to use when generating the user interface on the device;
accumulate the user input via the user interface on the device,
adapt a language form used in the device to one of an informal or formal form based on the accumulated user input,
update the current preferred language form with the adapted language form, and
generate the user interface on the device to reflect the current preferred language form.

14. The at least one computer-readable storage medium of claim 13, wherein the instructions further cause the machine to:
accumulate data related to the user's interaction with a device; and
measuring the accumulated data against a criteria for determining whether to adapt the language form to the informal or formal form, the criteria including meeting at least one threshold related to the user's interaction with the device, wherein the at least one threshold includes:
an amount of time the user spends using the device over a period of time;
a number of interactions between the user and the device via a user interface on the device;
a number of days that the device has been in use;
a number of times the user interacted with the device using an informal language form; and
a number of times the user interacted with the device using a formal language form.

15. The at least one computer-readable storage medium of claim 13, wherein the instructions further cause the machine to:
adapt the language form used in the device to one of an informal or formal form based on data related to the user's location when using the device, the user's location being one of a home location, a work location, a school location, a government location and a social location.

16. The at least one computer-readable storage medium of claim 13, wherein the instructions further cause the machine to:
adapt the language form used in the device to one of an informal or formal form based on data related to a user's role when using the device, the user's role being determined based on any one or more of a job title and a security level assigned to the user when using the device.

17. The at least one computer-readable storage medium of claim 16, wherein the user's role varies based on the user's location when using the device.

18. The at least one computer-readable storage medium of claim 13, wherein the instructions further cause the machine to:
adapt the language form used in the device to one of an informal or formal form based on data related to a user's behavior when using the device, including data related to social networking traffic transmitted and received using the device, resources accessed using the device and applications used on the device, wherein the resources include websites accessed using the device and wherein the applications used on the device include email, instant messaging and chat applications.

19. The at least one computer-readable storage medium of claim 13, wherein the instructions further cause the machine to:
notify an application generating the user interface on the device that the preferred language form has been updated; and
generate the user interface on the device to reflect the updated preferred language form.
